(19) United States
(12) Patent Application Publication
(10) Pub. No.: US 2023/0210632 A1
(43) Pub. Date: Jul. 6, 2023

(54) DENTAL REPARATIVE ARTICLE

(71) Applicants: Rick White, Woodland, WA (US); Kenneth W. Pierson, Visalia, CA (US)

(72) Inventors: Rick White, Woodland, WA (US); Kenneth W. Pierson, Visalia, CA (US)

(21) Appl. No.: 18/184,153

(22) Filed: Mar. 15, 2023

Related U.S. Application Data
(63) Continuation-in-part of application No. 18/149,313, filed on Jan. 3, 2023.
Application No. 18/149,313 is a continuation of application No. 16/868,656, filed on May 7, 2020, now Pat. No. 11,540,903.

(51) Int. Cl. A61C 13/107; A61C 5/77

(52) U.S. Cl. CPC A61C 13/0001; A61C 5/77; A61C 5/80

(57) ABSTRACT

Provided in this disclosure is a crown for a damaged tooth that is manufactured via metal injection molding and features an opening into which can be applied flowable dual-cure tooth colored material.

### CROSS-REFERENCE TO RELATED APPLICATIONS

This application is a continuation-in-part of U.S. Ser. No. 18/149,313, filed on Jan. 23, 2023, which claims priority to U.S. Ser. No. 16/868,656, filed May 7, 2020, now U.S. Pat. No. 11,540,903.

### I. BACKGROUND

### A. Technical Field

The present invention relates generally to restorative dentistry and, more particularly, to the interim restoration of a damaged anterior primary tooth, or the permanent restoration of a permanent tooth. The invention includes a novel manufacturing method to manufacture a crown, the novel crown itself, and a novel method of installing the crown onto a patient's tooth.

### B. Description of Related Art

It is common for a patient to damage a tooth, whether it be a crack in the enamel, a chip, decay or some other typical visually unattractive damage, the repair of which can be important to health as well as the patient's appearance and self-esteem. Children, as well as adults, damage teeth.

Clearly the health of the patient is an important consideration, but whether an adult, or a child in its formative years, self-esteem, as a function of physical appearance, cannot be discounted or overlooked. Whereas an adult will often opt for a more expensive restoration, primarily because of appearance, it is not uncommon for dentists to use the effective, but unattractive stainless-steel restorations.

As a consequence, there has been an increase in ongoing research relative to means of ameliorating the distractions that damage to an anterior tooth can present to a person. This invention is directed to alleviating that problem.

One solution to the problem of a cracked, chipped or even broken anterior tooth has been to fit the damaged tooth with a stainless-steel crown. In some cases, the visible metal, gold or steel, may be a distasteful and embarrassing distraction in one's appearance which can inhibit a smile, and detract from one's mood and, indeed, entire persona. It is important, therefore, that the dentist have available an alternative that permits the patient to retain, if not heighten, his or her level of self-esteem.

Wiedenfeld, who, in his U.S. Pat. No. 5,624,22 suggested a veneer constructed of a composite resin. The resin is, hopefully, adhered to a stainless-steel crown, which is etched to provide a surface that will receive and hold the resin.

Another approach to the problem is found in U.S. Pat. No. 5,538,429 to Mayclin who, with apparent focus on costs, suggests much the same approach as Wiedenfeld, i.e., cementing an overlay over a steel crown. Mayclin deviates from Wiedenfeld in that the overlay is provided with openings to permit the thickness of the completed crown to be thickened to enhance durability.

The patent to Zelesnick, U.S. Pat. No. 2,031,996, is a 1936 offering that teaches the cutting of a window in the face of a steel crown. The essence of Zelesnick is the provision of two or more anchors 11 which are intended to be imbedded in a porcelain layer that fits in the window with its edges between the cap and the tooth being restored. In this manner, a white porcelain layer is fashioned in a steel crown, presumably to reduce the amount of metal that will be seen by others as the person wearing such a restoration talks or smiles. It will be evident to even the casual observer, however, that a crown is present, and at least some metal will be apparent.

Of less significance in the environment of the present invention, yet part of the overall picture of the art, are those patents which provide a framework within which bonding materials may work to adhere a non-metallic cap to a metallic base.

Included in this art is the patent to Rieger, U.S. Pat. No. 4,846,718, which suggests a carrier cap, 12. Fung, in his U.S. Pat. No. 5,314,335 employs a wire mesh member 3, and Eldred U.S. Pat. No. 5,118,296 teaches a chemical composition which he refers to as his cohesion layer.

Finally, Burgess et al., in their U.S. Pat. No. 4,668,193, provides holes 4, as contrasted perhaps to the window of Zelesnick, to permit the securing of a veneer. Burgess et al., however, is relevant only to posterior teeth, where appearance is less relevant, and strength is vital.

As will become apparent from a reading of the forthcoming detailed description, none of these prior art efforts suggest the novel approach of the present invention.

### II. SUMMARY

The primary focus of the present invention is the provision of a method, at least on an interim basis, of effecting a cosmetic and structurally sound restoration of a damaged anterior tooth.

This is accomplished, in accordance with the present invention, by a restorative crown for a damaged anterior tooth including a framework configured to be fitted and placed on the tooth and defining a void space or pocket between the framework and the tooth, for confining and containing a curable material flowed into the pocket. When hardened, the curable material integrally bonds to the framework and the tooth to become the finished crown. A facial surface of the framework is provided for defining an opening to the pocket for admitting a flow of the curable material. A palatal/lingual surface of the framework is provided, opposed to the facial surface, for defining a solid surface for containing the flow of the curable material. A mesial edge and a distal edge are also provided for defining first and second vertical edges of the opening to the pocket. An incisal edge of the framework is defined by the two vertical edges that turn toward each other to join in a straight line to define a horizontal edge of the opening to the pocket.

In the restorative crown of the present invention, the first and second vertical edges and the incisal edge define a junction between the framework and the curable material. The curable material is preferably a dual-cure composite material. The curable material preferably has a color selected to match the original color of the damaged anterior tooth. The framework is preferably formed of stainless steel.

The restorative crown of the present invention also includes a gusset molded into the framework at a position lingual to the incisal edge of the framework. The gusset is configured to engage into the curable material before it is cured, and provide a locking surface around which the curable material is affixed, thereby firmly locking the material against a stainless-steel junction surface defined by the first and second vertical edges and the incisal edge.

In the restorative crown of the present invention, the gusset includes a first gusset member respectively attached to a first side of the framework, proximate to a first vertical edge, and a second gusset member, attached to a second side of the framework, proximate to a second vertical edge. The first and second gusset members are formed integrally with an attachment portion attached proximate to the incisal edge of the framework.

In the restorative crown of the present invention, the first and second gusset members protrude inwardly from the respective first and second vertical edges of the framework at locations on the crown palatal to the junction surface of the vertical edges. The gusset members are triangular and include outside edges longer than inside edges at a middle of the framework. The first and second gusset members are molded as one piece at the respective shortest edges and formed integrally with the attachment portion in the middle of the framework.

Accordingly, it is an objective of the present invention to effect a cosmetically pleasing restoration of a damaged tooth in a manner which will not cause the patient undue discomfort or require that he or she remain in an uncomfortable position for an extended period.

A further objective of the present invention is to effect the formation of a cosmetically pleasing crown for an anterior tooth which is structurally sufficient to withstand the use and abuse to which a patient might be likely to expose the crown during the normal activities of daily living without embarrassment or discomfort.

It is a distinct advantage, and thus another objective accomplished, by virtue of the ease with which the restoration of the present invention can be accomplished in a single visit, thus effecting further savings in time and money for the patient.

Yet another, and still further, objective of the present invention is to provide a restoration with all of the foregoing described attributes, at a cost which is less than the more conventional cast, or custom fit prosthesis, and is thus commensurate with the reality that the tooth being restored may not be permanent.

The foregoing, as well as other objectives and features will become apparent to those skilled in the art of restoration of anterior teeth from a reading of the following detailed description, taken in conjunction with the accompanying drawings, wherein:

### III. BRIEF DESCRIPTION OF THE DRAWINGS

FIG. 1 is a side view of a crown formed in accordance with the present invention and manufactured by the inventive method and further illustrating a facial opening in the framework.

FIG. 2 is a perspective top view of the framework of FIG. 1.

FIG. 3 is a view of the leading edge of the framework of FIG. 1.

FIG. 4 is a perspective view of the framework of FIG. 1.

FIG. 5 is a top view of the facial panel and leading edge of the framework.

FIG. 6 is a diagram of the various steps in the process of creating the restoration of the present invention.

FIG. 7 illustrates the prepared tooth ready for the framework (crown) to be fitted.

FIG. 8 illustrates filling the space between the prepared tooth and the framework (crown) with the flowable, dual cure, bio-active material.

FIG. 9 illustrates light curing the bonding/filling dual cure composite material.

FIG. 10 illustrates the finishing and polishing process.

FIGS. 11A and 11B illustrate an alternate embodiment in accordance with the present invention.

### IV. DETAILED DESCRIPTION

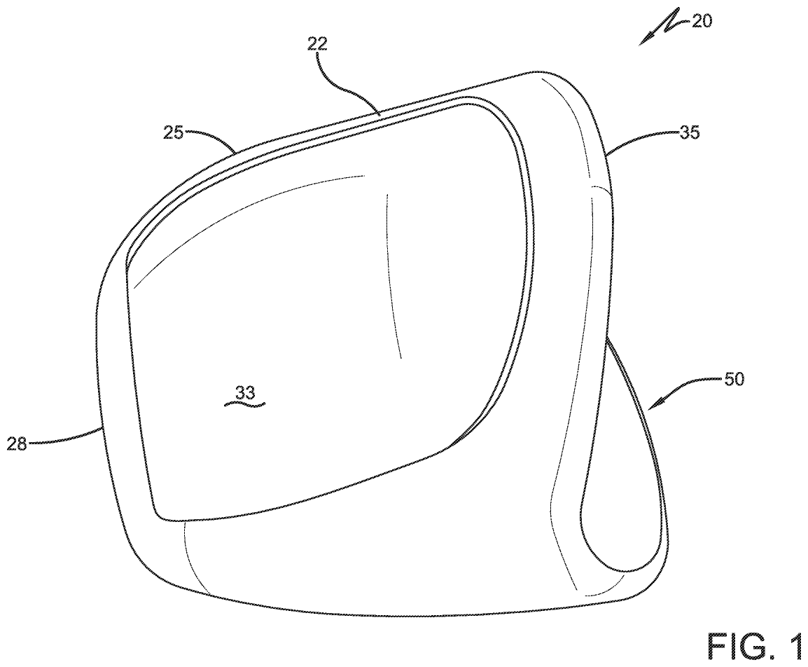

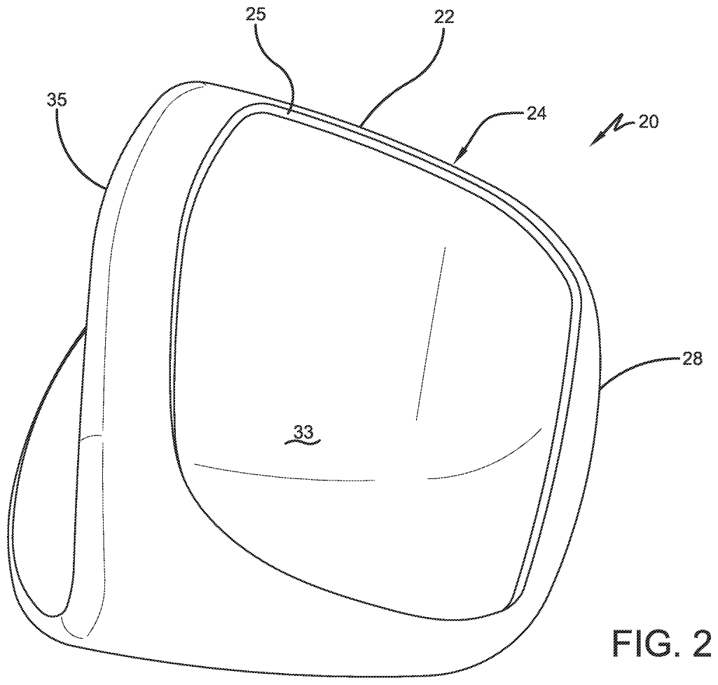

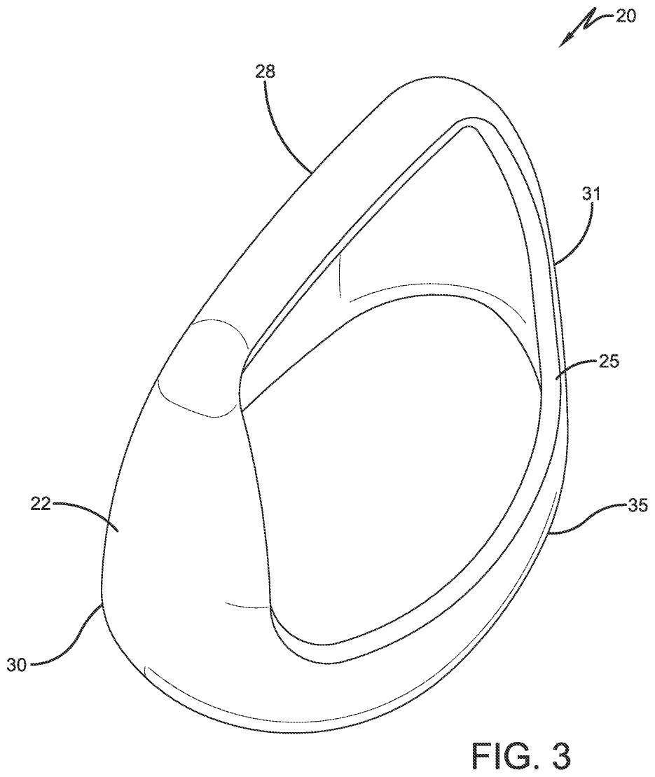

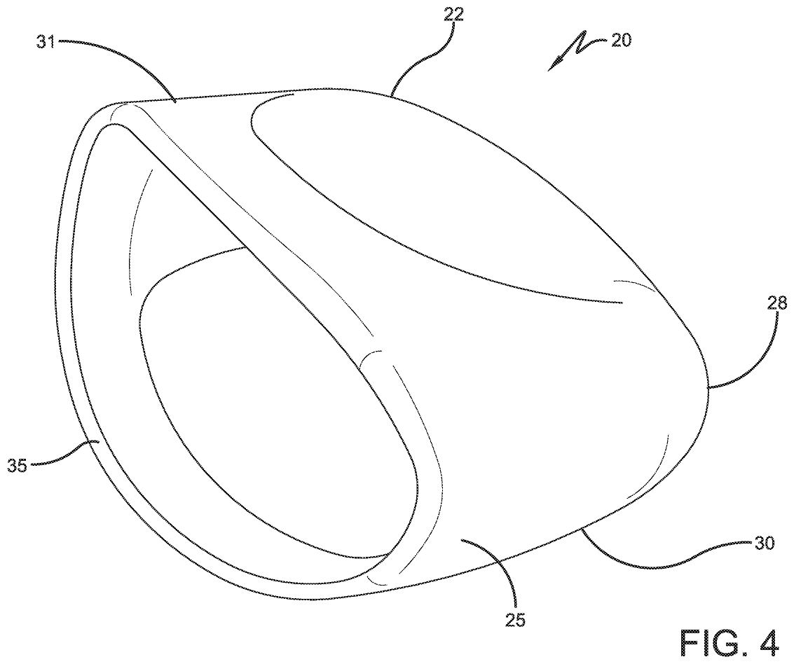

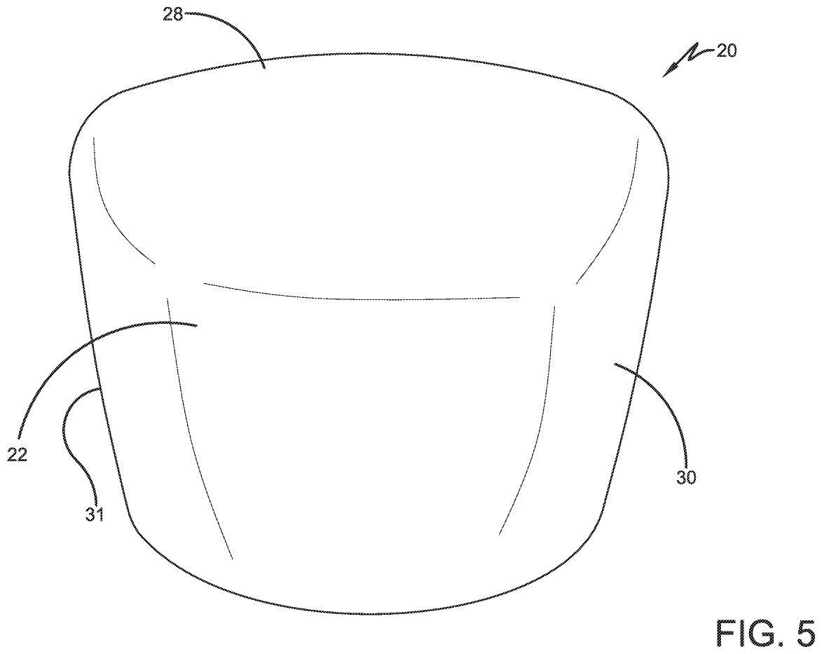

With reference now to the drawings, and initially to FIGS. 1 through 5, an anterior crown 20, constructed in accordance with the present invention is illustrated from various angles.

In its preferred form, the crown 20 comprises a framework or envelope 22, constructed of a formable, non-corrosive material such as stainless-steel. The framework 22 is preformed to define a pocket 50 which closely approximates the shape and size of the prepared anterior tooth.

The framework 22 is initially formed to its general configuration as previously referenced, such as to define a rearward or palatal panel 24, a facial window 25, joined along a leading edge 28, and defining interproximal walls, or side panels 30 and 31, respectively. Previously, in the prior art, when the initial shape or profile of the scaffold 22 was established, an opening was cut in the facial panel, as is illustrated in U.S. Pat. No. 5,951,294. However, one aspect of the present invention is a new manufacturing method which enables the facial panel 25 to be manufactured with a pre-made opening 33, thereby eliminating the need to create such an opening from a solid facial panel, as described in U.S. Pat. No. 5,951,294. In fact, the opening 33 in the facial panel 25 of this invention is so large, the opening 33 is much larger than the surface area of the facial panel 25, so that the facial panel 25 resembles a border around the opening 33. Specifically, the article 20 is manufactured of a suitable material, such as stainless-steel via metal injection molding, also known as “MIM.”

Metal injection molding (MIM) is a metalworking process in which finely powdered metal is mixed with binder material to create a feedstock that is then shaped and solidified using injection molding. The molding process allows high volume, complex parts to be shaped in a single step. After molding, the part undergoes conditioning operations to remove the binder and densify the powders. Finished products are small components used in many industries and applications.

The ability to combine several operations into one process ensures MIM is successful in saving lead times as well as costs, providing significant benefits to manufacturers. Traditional metalworking processes often involve a significant amount of material waste, which makes MIM a highly efficient option for the fabrication of complex components consisting of expensive alloys, such as stainless steel, as in this application.

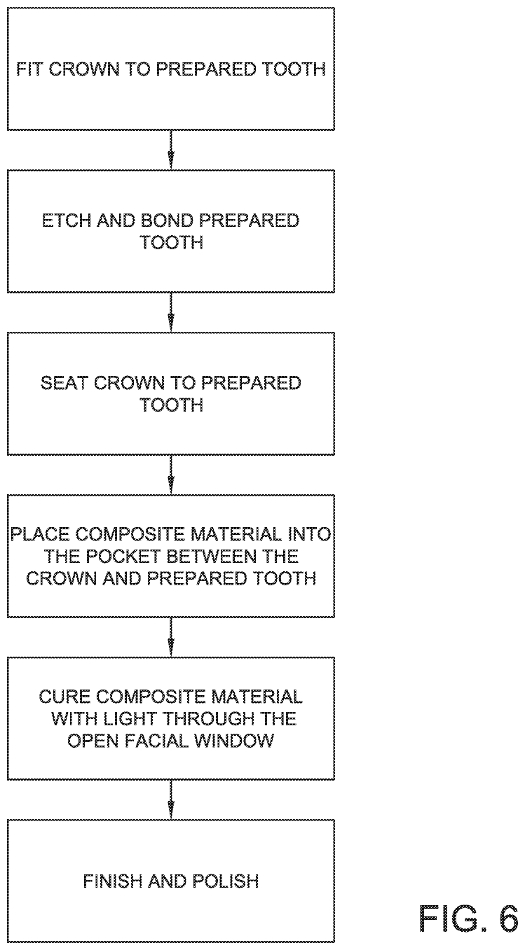

With reference to FIGS. 1-6, an opening 33 is preformed into the facial panel, via the MIM process. The opening 33 created in substantially the entire facial panel 25 of the scaffold 22, as perhaps best seen in FIGS. 1-5, so as to define a substantial opening 33 in the facial panel 25, while maintaining structural integrity by providing a circumferential band 35 contiguous with an associated gum line of the associated patient and interconnecting the proximal sides 30 and 31. The specific scaffold 22 is selected from several standard sizes, depending on the size and shape of the associated tooth to be restored.

Having thus selected the structural framework from which the crown of the present invention is to be formed, the patient's tooth to be restored by the said crown is prepared by first removing all unstable material from the tooth which may be the consequence of decay or traumatic damage, and etching the surface of the tooth in any well-known manner to better provide a bonding surface. (FIG. 7 illustrates a tooth T that has been prepared.)

The framework 22 is then placed over the previously prepared tooth T to be restored, as seen in FIG. 7.

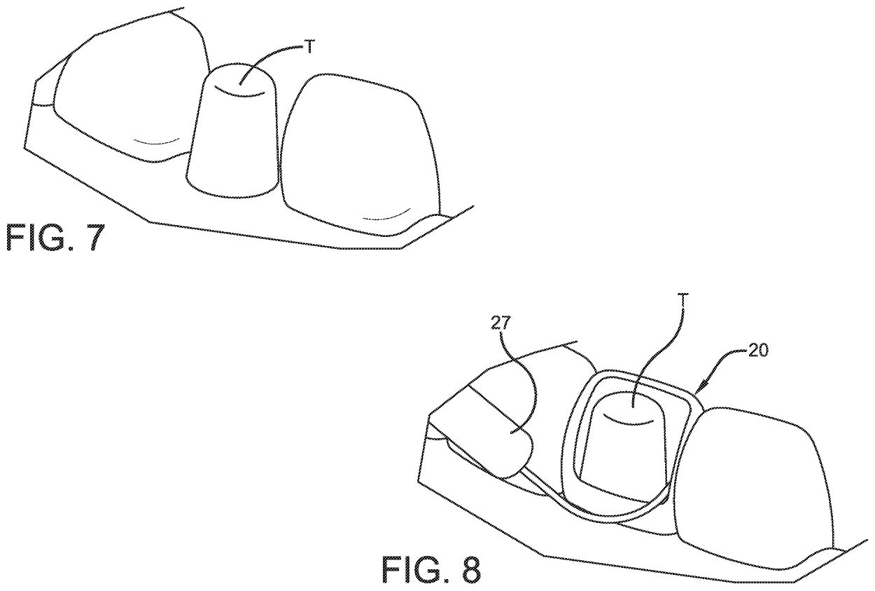

Once the framework 22 has been fitted to the tooth T as seen in FIG. 8, the pocket 50 defined by the interior of the framework 22 is filled with a suitable quantity of dual cure composite material M, such as by an appropriate syringe 27. Suitable materials can be chosen with the application of sound dental judgment, but the currently preferred material is sold under the brand name Activa and is available from Pulpdent Corporation of Watertown, Mass., USA. The product is described in U.S. Pat. Nos. 6,797,767; 7,157,502; 7,371,782; 8,292,625; 8,535,058; and 8,735,464, which are incorporated herein by reference. A small quantity of cured excess composite material M will be removed, and the remainder will be shaped and polished.

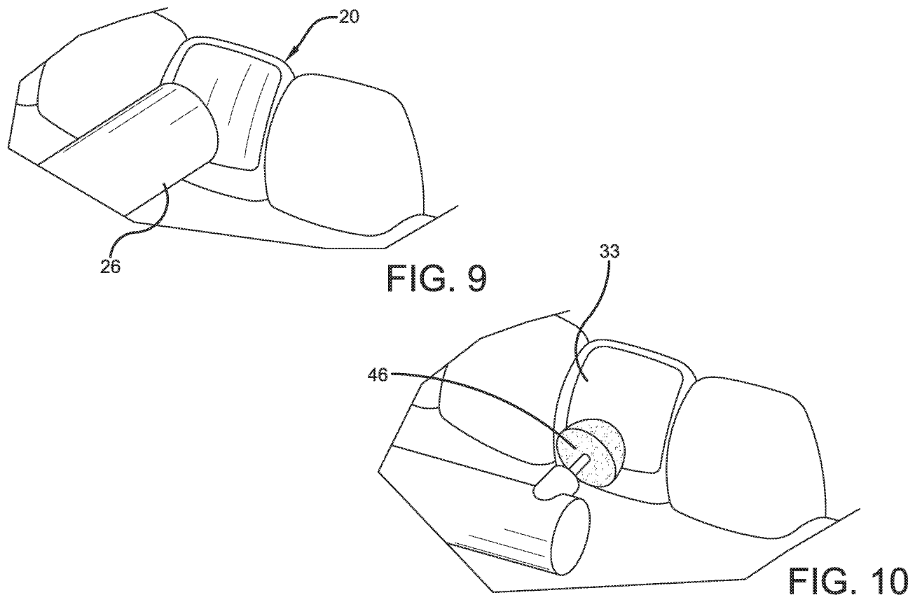

With reference to FIG. 9, the material will cure, on its own, via the passage of time, or the cure can be speeded up by the application of the appropriate wavelength of light via a source 26 of the light cure gun. The material may be colorized if necessary to, in accordance with this aspect of the invention, to closely approximate the color of teeth of the patient immediately adjacent to the tooth to be restored. In this manner the restorative crown will blend into the overall appearance of the mouth and is distinguished by the casual observer's inability to discern the existence of a restoration.

Also, in accordance with another aspect of the invention, there will be a layer, or a continuum of material, disposed within the confines of the opening 33, defining a film of composite material which transcends the opening 33, the thickness of which is determined by the area between the tooth T, the framework, and the cap disposed about the scaffold. Otherwise stated, the composite material M within the confines of the opening 33 will, in accordance with the invention, bond the framework to the tooth and completely cover the facial opening 33 of the framework and about the leading edge 28, thereby obliterating any hint of the framework which lies beneath the material. The obvious result is a restoration which, for all intents and purposes, has the appearance of being a normal tooth.

As shown in FIG. 10, once the composite material M has cured, as a final step in the creation of the prosthesis, the crown 20 is shaped and polished by associated polishing wheel 46 and otherwise finished to provide an aesthetically pleasing and structurally strong restoration, which will last as long as the restored tooth remains and, because of the relatively nominal cost, can be discarded without undue concern when the primary tooth falls out or is removed.

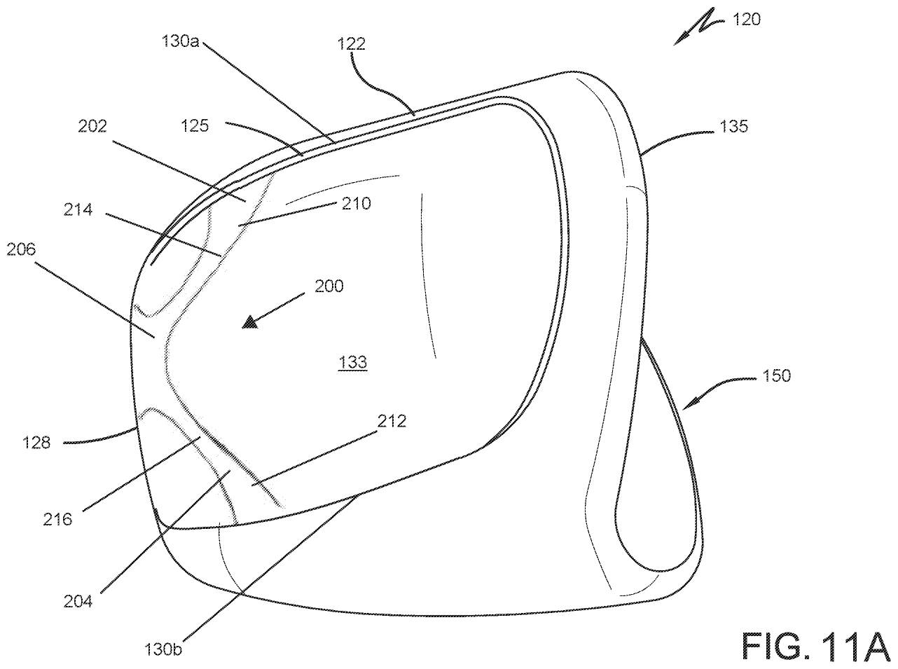

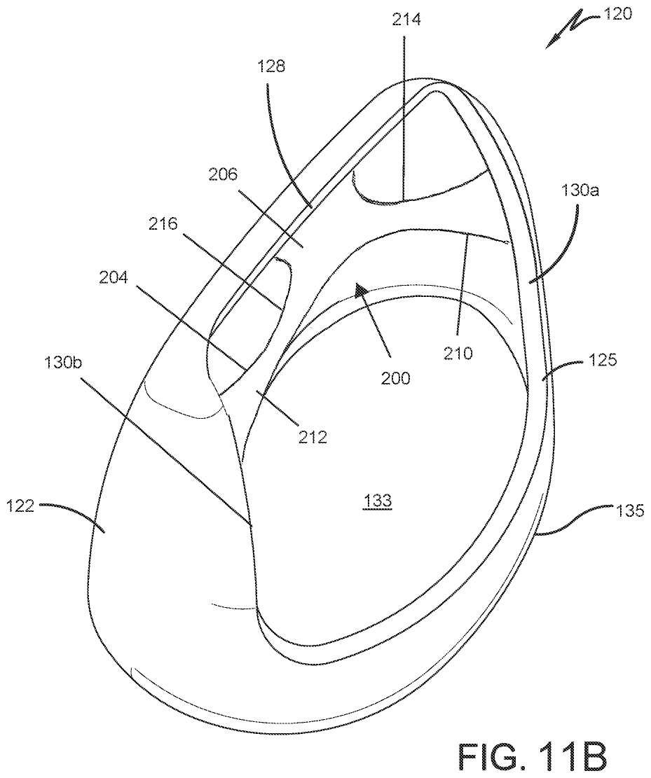

FIG. 11 depicts an alternate embodiment of an “open face” or “window” crown for providing a more aesthetic crown design. The alternate embodiment of FIG. 11 is similar to the aforementioned embodiments and thus includes structures and configurations similar to the aforementioned embodiments except insofar as specifically described hereinafter. For the purpose of characterizing this alternative embodiment, the parts or surfaces of teeth will be identified to orient the inventive crown to the specific part(s) of a tooth. Every tooth has five surfaces. Each surface has a name as follows:

Incisal or Occlusal is the surface that contacts an opposing tooth when the upper and lower teeth are closed or touching each other. If that surface is broad such as a molar or premolar and used for crushing or grinding food, it is called an occlusal surface. If that surface is an edge or point used for cutting or tearing food, it is called an incisal surface. Incisal surfaces are only found on the 6 upper and 6 lower anterior teeth. Occlusal surfaces are only found on the posterior teeth behind the anterior teeth.

Buccal or Facial—Buccal refers to the cheeks and facial refers to the face. Therefore technically, the buccal surfaces of the teeth are those surfaces that touch the cheeks. The facial surfaces of teeth are those that touch or point toward the face. Both the cheeks and the lips are part of the face so often the terms buccal and facial are used interchangeably, and no matter which term is used any dentist would understand that both terms identify the outside tooth surfaces that can be seen when the upper and lower teeth are closed.

Palatal or Lingual—Palatal refers to the Palate and Lingual refers to the tongue. The palatal surface refers to the tooth surfaces that touch the palate and therefore refers only to upper teeth. Lingual surfaces of the teeth are the surfaces that can touch the tongue. Since the tongue can touch the inner surface of both the upper and lower teeth, lingual refers to the inner surface of both the upper and lower teeth.

Mesial and Distal are the surfaces of the teeth that touch each other when the mouth is open. All the surfaces that face toward the front of the mouth are named mesial surfaces. Every tooth has one mesial surface. In a normal dentition when all the teeth are present, every mesial surface touches the distal surface of the adjacent tooth in front of it, except where 2 mesial surfaces touch each other in the very front (midline) of the mouth. All the surfaces of the teeth that face toward the back of the mouth are named distal surfaces. Every tooth has one distal surface. In a normal dentition when all the teeth are present, every distal surface touches the mesial surface of the adjacent tooth behind it except the distal surfaces of the four back teeth which do not touch another tooth.

As shown in the alternate embodiment of FIGS. 11A and 11B, a crown 120 includes a metal portion or framework 122 that is fitted and placed on the prepared tooth. The framework 122 is used to confine and contain a curable material. The framework 122 thus defines a pocket or void space as a surrounding volume between the framework 122 and the tooth, and the curable material is flowed into the pocket. Preferably, the curable material is a dual cure flowable white material. When hardened, the dual cure flowable white material integrally bonds to the metal framework 122 and together the metal framework 122 and the hardened material become the finished crown.

The alternate embodiment of FIGS. 11A and 11B is an open face crown 120 which is strong and durable but shows less metal, thus making it more esthetic. In contrast to the aforementioned embodiments, the alternate embodiment is characterized by design variations as follows. The junction of the white light-cured material and the stainless-steel framework 122 is formed along an incisal edge 128 of the crown 120 instead of along the facial surface 125 of the crown 120 just below the incisal edge 128, as had been depicted in the embodiment of FIG. 1. This is accomplished by configuring the framework 122 so that the vertical edges 130a, 130b of the framework 122 continue in an incisal direction all the way to the incisal edge 128 of the crown 120. At that maximal point the two vertical edges 103a, 130b turn toward each other to join in a straight line to define the incisal edge 128.

As additionally depicted in FIGS. 11A and 11B, a facial surface 125 of the framework 122 defines an opening 133 to the pocket 150 for admitting a flow of the curable material. A palatal/lingual surface of the framework 122 is opposed to the facial surface 125 for defining a solid surface for containing the flow of the curable material. The first and second vertical edges 130a, 130b are respectively defined by one or the other of a mesial edge and a distal edge and define the opening 133 to the pocket 150. And as described hereinabove, the incisal edge 128 of the framework 122 is defined by the two vertical edges 130a, 130b that extend up from a circumferential band 135 turn toward each other to join in a straight line to define a horizontal edge of the opening 133 to the pocket 150.

With ongoing reference to FIGS. 11A and 11B, maximal strength and support are provided for the junction of the vertical edges 130a, 130b to ensure that there is no separation between the light-cured flowable white material. Specifically, the first and second vertical edges 130a, 130b and the incisal edge 128 define the junction between the framework and the curable material. While the curable material is characterized herein as a light-cured flowable white material, it is to be appreciated that the curable material can alternatively have any specific color selected to match an original color of the damaged anterior tooth. Moreover, the framework 122 is preferably formed of stainless steel, though it is to be appreciated that any other suitably durable material could alternatively be selected.

With additional ongoing reference to FIGS. 11A and 11B, the crown 120 includes certain additional design features to differentiate from the previous embodiment. In one aspect, the crown 120 includes a gusset 200 molded into the framework 122 at a position lingual to the established junction surface along the incisal edge 128 of the framework 122. The gusset 200 is preferably made of stainless steel. The gusset 200 is configured to engage into the white material while it is flowed into the pocket 150, before it is cured, and thereby provides a locking surface around which the while material is affixed. In this manner, the gusset 200 thereby firmly locks the cured white material against a stainless-steel junction face defined by the vertical edges 130a, 130b and the incisal edge 128.

With continued reference to FIGS. 11A and 11B, the gusset 200 includes two gusset members 202, 204, a first gusset member 202 attached to a first side of the framework 122, proximate to a first vertical edge 130a, and a second gusset member 204, attached to a second side of the framework 122, proximate to a second vertical edge 130b. These gusset members 202, 204 are formed integrally with an attachment portion 206 which is attached to the incisal edge 128 of the framework 122. The gusset 200 is included in the embodiment where the junction between the metal framework 122 of the crown 120 and the white light-cured material is located on the edge of the incisal surface 128. Such gussets 200 both add strength to the framework 122 and provide additional retention of the white material.

With further reference to FIGS. 11A and 11B, the stainless-steel gusset members 202, 204 protrude inwardly from the inside surface of the respective vertical edges 130a, 130b of the framework 122 at a location on the crown 120 palatal to the junction surface of the vertical edges 130a, 130b. The stainless-steel gusset 200 is designed to be sufficiently thick to provide adequate strength and resistance to bending or distortion forces that would be applied to the crown 120 during normal dental use. Each stainless-steel gusset member 202, 204 is preferably triangular and having outside edges 210, 212 longer than inside edges 214, 216 at the middle of the framework 122. The two gusset members 202, 204 are preferably molded as one piece at the respective shortest edges 214, 216 and formed integrally with the attachment portion 206 which is in the middle of the framework 122 so that there is no separation between them. The gusset members 202 are placed at a location as far in the palatal direction as possible within the framework 122 yet still leaving sufficient space between a palatal surface of the gusset 200 and an interior surface of the framework 122 where the flowable material can be injected.

Having thus disclosed a novel method of forming a crown for an anterior tooth to be restored, as well as the resultant crown, what is claimed as my invention is:

What is claimed:

1. A restorative crown for a damaged anterior tooth comprising:
a framework configured to be fitted and placed on the tooth, and defining a pocket between the framework and the tooth, for confining and containing a curable material flowed into the pocket, such that, when hardened, the curable material integrally bonds to the framework and the tooth to become a finished restoration;
a facial surface of the framework for defining an opening to the pocket for admitting a flow of the curable material;
a palatal/lingual surface of the framework, opposed to the facial surface, for defining a solid surface for containing the flow of the curable material;
a mesial edge and a distal edge for defining first and second vertical edges of the opening to the pocket; and
an incisal edge of the framework defined by the two vertical edges that turn toward each other to join in a straight line to define a horizontal edge of the opening to the pocket.

2. The restorative crown of claim 1, wherein the first and second vertical edges and the incisal edge define a junction between the framework and the curable material.

3. The restorative crown of claim 1, wherein the curable material is a dual-cure composite material.

4. The restorative crown of claim 1, wherein the curable material has a color selected to match an original color of the damaged anterior tooth.

5. The restorative crown of claim 1, wherein the framework is formed of stainless steel.

6. The restorative crown of claim 1, further comprising a gusset molded into the framework at a position lingual to the incisal edge of the framework, wherein the gusset is configured to engage into the curable material before it is cured, and provide a locking surface around which the curable material is affixed, thereby firmly locking the material against a stainless-steel junction surface defined by the first and second vertical edges and the incisal edge.

7. The restorative crown of claim 6, wherein the gusset includes a first gusset member respectively attached to a first side of the framework, proximate to a first vertical edge, and a second gusset member, respectively attached to a second side of the framework, proximate to a second vertical edge, wherein the first and second gusset members are formed integrally with an attachment portion attached proximate to the incisal edge of the framework.

8. The restorative crown of claim 7, wherein the first and second gusset members protrude inwardly from the respective first and second vertical edges of the framework at locations on the crown palatal to the junction surface of the vertical edges.

9. The restorative crown of claim 7, wherein the gusset members are triangular and comprise outside edges longer than inside edges at a middle of the framework.

10. The restorative crown of claim 9, wherein the first and second gusset members are molded as one piece at the respective shortest edges and formed integrally with the attachment portion in the middle of the framework.

11. A restorative crown for a damaged anterior tooth comprising:
a framework configured to be fitted and placed on the tooth, and defining a pocket between the framework and the tooth, for confining and containing a curable material flowed into the pocket, such that, when hardened, the curable material integrally bonds to the framework and the tooth to become a finished restoration;
a facial surface of the framework for defining an opening to the pocket for admitting a flow of the curable material;
a palatal/lingual surface of the framework, opposed to the facial surface, for defining a solid surface for containing the flow of the curable material;
a mesial edge and a distal edge for defining first and second vertical edges of the opening to the pocket;
an incisal edge of the framework defined by the two vertical edges that turn toward each other to join in a straight line to define a horizontal edge of the opening to the pocket; and
a gusset molded into the framework at a position lingual to the incisal edge of the framework, wherein the gusset is configured to engage into the curable material before it is cured, and provide a locking surface around which the curable material is affixed, thereby firmly locking the material against a stainless-steel junction surface defined by the first and second vertical edges and the incisal edge.

12. The restorative crown of claim 11, wherein the gusset includes first and second gusset members respectively attached to a first side of the framework, proximate to a first vertical edge, and a second gusset member, attached to a second side of the framework, proximate to a second vertical edge, wherein the first and second gusset members are formed integrally with an attachment portion attached proximate to the incisal edge of the framework.

13. The restorative crown of claim 12, wherein the first and second gusset members protrude inwardly from the respective first and second vertical edges of the framework at locations on the palatal to the junction surface of the vertical edges.

14. The restorative crown of claim 12, wherein the gusset members are triangular and comprise outside edges longer than inside edges at a middle of the framework.

15. The restorative crown of claim 14, wherein the first and second gusset members are molded as one piece at the respective shortest edges and formed integrally with the attachment portion in the middle of the framework.

16. The restorative crown of claim 11, wherein the first and second vertical edges and the incisal edge define a junction between the framework and the curable material.

17. The restorative crown of claim 11, wherein curable material is a dual-cure composite material.

18. The restorative crown of claim 11, wherein the curable material has a color selected to match an original color of the damaged anterior tooth.

19. The restorative crown of claim 11, wherein the framework is formed of stainless steel.
